(19) United States
(12) Patent Application Publication
(10) Pub. No.: US 2026/0149617 A1
(43) Pub. Date: May 28, 2026

(54) BIDIRECTIONAL PROTOCOL-INDEPENDENT MULTICAST RENDEZVOUS POINT ON A HIGH-AVAILABILITY DEVICE PAIR

(71) Applicant: HEWLETT PACKARD ENTERPRISE DEVELOPMENT LP, Spring, TX (US)

(72) Inventors: Tathagata Nandy, Bangalore (IN); Subramanian Muthukumar, Bangalore (IN); Chethan Chavadibagilu Radhakrishnabhat, Bangalore (IN)

(21) Appl. No.: 19/042,202

(22) Filed: Jan. 31, 2025

(30) Foreign Application Priority Data
Nov. 27, 2024 (IN) 202441092793

(51) Int. Cl. H04L 12/18; H04L 45/16

(52) U.S. Cl. CPC H04L 12/185; H04L 12/1895; H04L 45/16

(57) ABSTRACT

In a network, a network device can receive, from a second network device, a notification comprising information associated with a join request for a multicast group received at the second network device. Here, the network device and the second network device can be rendezvous points (RPs) for the multicast group. The network device can determine, based on the notification, a first port of the network device corresponding to a second port of the second network device. The join request can be received at the second port from a device coupled to the first and second ports. The network device can then select the first port as an egress port for multicast traffic of the multicast group and, upon receiving a packet of the multicast traffic, send the packet to the device via the first port.

### BACKGROUND

A network device, such as a switch, may support different network protocols and services, such as multicast. For example, the network device can run a multicast protocol, such as bidirectional Protocol-Independent Multicast (PIM-BIDIR).

### BRIEF DESCRIPTION OF THE FIGURES

FIG. 1A illustrates an example of a network with a high-availability device pair operating as a PIM-BIDIR rendezvous point (RP), in accordance with an aspect of the present application.

FIG. 1B illustrates an example of a high-availability device pair facilitating failover while operating as a PIM-BIDIR RP, in accordance with an aspect of the present application.

FIG. 2 illustrates an example of a network with a multi-chassis link aggregation group (MC-LAG) coupled to a high-availability device pair operating as a PIM-BIDIR RP, in accordance with an aspect of the present application.

FIG. 3 presents a flowchart illustrating an example of a process of a network device in a high-availability device pair processing multicast traffic while operating as a PIM-BIDIR RP, in accordance with an aspect of the present application.

FIG. 4 presents a flowchart illustrating an example of a process of a network device in a high-availability device pair facilitating efficient failover, in accordance with an aspect of the present application.

FIG. 5 presents a flowchart illustrating an example of a process of a network device in a high-availability device pair processing multicast traffic received from an MC-LAG while operating as a PIM-BIDIR RP, in accordance with an aspect of the present application.

FIG. 6 illustrates an example of a computing system facilitating a PIM-BIDIR RP on a high-availability device pair, in accordance with an aspect of the present application.

FIG. 7 illustrates an example of a computer-readable medium (CRM) facilitating a PIM-BIDIR RP on a high-availability device pair, in accordance with an aspect of the present application.

In the figures, like reference numerals refer to the same figure elements.

### DETAILED DESCRIPTION

In various Internet applications, multicast is frequently used to distribute content from a source to multiple hosts via one or more network devices, such as switches. Efficient distribution of multicast traffic can improve the performance of a network. A network-layer multicast protocol, such as PIM, can be used to distribute content in a network. In some scenarios, a host can send a client join request (e.g., an Internet Group Management Protocol (IGMP) join request or a Multicast Listener Discovery (MLD) join request) to an to a network device, which can couple the host, to receive traffic of a multicast group. This network device can be referred to as a requesting network device. The requesting network device can send a network join request (e.g., a PIM join request) to a source network device coupled to the source of the multicast group. The source network device can then start forwarding multicast traffic from the source to the requesting network device.

A network may include a high-availability device pair where at least two network devices are associated with the same network address (e.g., a distributed Internet Protocol (IP) address). Consequently, any of these network devices can receive and forward packets based on the distributed IP address. Here, these network devices can be peer network devices of each other in the device pair. If one of the network devices becomes unavailable, the other network device can facilitate failover and continue to forward traffic based on the distributed IP address. If the high-availability device pair operates as a PIM-BIDIR, the multicast join requests and the corresponding multicast traffic can be sent to the distributed IP address. Because both network devices can use the same distributed IP address, one of these network devices may receive a join request and another network device may receive the corresponding multicast traffic, thereby causing traffic loss. As a result, operating the high-availability device pair as a PIM-BIDIR RP can be challenging.

The aspects described herein address the problem of traffic loss caused by operating a high-availability device pair as a PIM-BIDIR RP by (i) synchronizing join requests among the network devices for determining the hosts requesting to receive multicast traffic; and (ii) synchronizing forwarding information for incoming multicast traffic for facilitating efficient failover. By synchronizing the join requests, both network devices can determine the egress ports for the incoming multicast traffic. Furthermore, when the forwarding information is synchronized, both network devices can program their respective forwarding hardware with corresponding multicast forwarding entries even without receiving the multicast traffic. As a result, if one of the network devices becomes unavailable, the other network device can readily start forwarding the incoming multicast traffic.

Currently, at least two network devices can be configured as a high-availability device pair. These network devices can be allocated the same IP address, which can be referred to as a distributed IP address. Other devices can be coupled to both network devices either via an MC-LAG or individual links. Since both network devices are associated with the same IP address, other devices can select one of the network devices for forwarding traffic. As a result, if one of the network devices becomes unavailable, the traffic can still be forwarded to the other network device using the same IP address. Typically, the device pair can aggregate traffic from a plurality of user devices. As a result, the device pair can be configured to operate as the RP for distributing multicast traffic (i.e., the multicast data flow) associated with the PIM-BIDIR protocol. The multicast traffic can include a flow of multicast data packets of the multicast group.

If a user device requests multicast traffic of a multicast group by sending a client join request (e.g., an IGMP join), the user device can be referred to as a requesting host or host. The network device coupled to the host can be referred to as the requesting network device. On the other hand, if the user device sends the multicast traffic (or the multicast data flow) of the multicast group, the user device can be referred to as the source of the multicast group. The network device coupled to the source can be referred to as the source network device. For the PIM-BIDIR protocol, the multicast traffic of the multicast group can be distributed via a root-path multicast tree (RPMT) in the network. Since the RPMT is rooted at the PIM-BIDIR RP, the RPMT can be a source-independent multicast tree (i.e., not associated with a particular source). Instead of forwarding the multicast traffic to individual recipients, the source network device can forward the multicast traffic to the RP via the RPMT. The RP can then forward the multicast traffic to a respective requesting network device.

Therefore, to receive the multicast traffic, a host can send the client join request (e.g., an IGMP join) to the requesting network device, which can then send a network join request (e.g., a PIM-BIDIR join) to the RP. Since the device pair can operate as the RP, the network join request can be forwarded to one of the network devices in the device pair based on the distributed IP address. Similarly, if the source network device is coupled to the device pair via respective individual links, one of the network devices can receive the multicast traffic of the multicast group pair based on the distributed IP address. However, if the network join request is received by one network device and the multicast traffic is received by the other network device of the device pair, the multicast traffic may not be forwarded to the requesting network device.

Furthermore, the network device receiving the multicast traffic can become unavailable (e.g., due to a link or node failure). Based on the distributed IP address, the operational network device of the device pair can start receiving the multicast traffic from the source network device. However, when a multicast packet reaches the operational network device, the forwarding hardware of this network device may not detect a matching forwarding entry. The network device can then determine the corresponding route entry and program the entry in the forwarding hardware. This process can be inefficient and may cause traffic loss.

To address this issue, the network devices of the device pair can exchange information and configure themselves to process the network join requests and forward multicast traffic efficiently. The device pair can operate as the RP for a multicast group based on the PIM-BIDIR protocol. Therefore, the RPMT associated with the multicast group can be rooted at the device pair. During operation, a host can send a client join request (e.g., an IGMP join) to join the multicast group. The requesting network device, which is coupled to the host, can receive the client join request. In response, the requesting network device can send a corresponding network join request (e.g., a PIM join) to the RP, which can be the device pair. The requesting network device can send the network join request to the distributed IP address. Therefore, one of the network devices of the device pair can receive the network join request via a local port of the network device.

The network device can then provide the information associated with the join request to its peer network device in the device pair. The information can include the multicast group (e.g., the multicast IP address associated with the multicast group) and the identifier of the port that has received the join request. The peer network device can then determine a corresponding port of the peer network device (i.e., the corresponding port of itself) based on a matching policy. The matching policy can indicate the ports coupled to the requesting network device based on a symmetric matching or a port mapping. For the symmetric matching, the corresponding port can have the same port identifier. If the port identifier of the port that has received the join request is X, the corresponding port identifier of the peer network device can also be X. For the port mapping, the network devices in the device pair can maintain a mapping between the port identifiers of the ports coupled to the requesting network device. The peer network device can then determine the local port coupled to the requesting network device based on the mapping. The mapping can be manually configured by an administrator of the network.

In this way, the peer network device can identify the port coupled to the requesting network device based on the matching policy. Subsequently, the peer network device can emulate the receiving of the network join request for the multicast group via the port. For example, the peer network device can provide the network join request to a multicast daemon (e.g., a PIM daemon) indicating that the network join request is received from the port. Here, the multicast daemon can be a piece of software running on at least one processing resource on the network device and can facilitate a multicast protocol, such as the PIM protocol, on the network device. As a result, the peer network device can determine that the multicast traffic of the multicast group is requested from the port. Accordingly, the network device can add the port as an egress port for the multicast traffic of the multicast group. In this way, both network devices of the device pair can have an egress port via which the multicast traffic can be forwarded. Hence, if any of the network devices receive the multicast traffic from the source network device, the multicast traffic can be forwarded to the requesting network device via the local egress port of the network device that receives the multicast traffic.

Because the device pair operates as the RP for the multicast group, the source network device can send the multicast traffic to the distributed IP address of the device pair. Consequently, one of the network devices can receive the multicast traffic. When the first packet of the multicast traffic is received by the network device, the network device can program its forwarding hardware with a corresponding multicast forwarding entry. The entry can be in the multicast forwarding data structure in the ternary content-addressable memory (TCAM) of the forwarding hardware. The entry can indicate the port that has received the packet as the ingress port and the port that has received (or emulated to receive) the join request as the egress port. It should be noted that the entry may indicate a plurality of egress ports since the network device may receive join requests from multiple downstream devices.

When the network device programs the entry in its forwarding hardware, the network device can synchronize the information of the entry with the peer network device. The information can indicate the multicast group and respective identifiers of ingress and egress ports of the multicast traffic of the multicast group. Based on the synchronization of the join request, both network devices have already determined the egress ports of the multicast traffic. Based on the synchronization of the entry, the peer network device can determine the local ingress port of the peer network device, which has received the information, using the matching policy (e.g., symmetric matching or port mapping). Accordingly, the peer network device can also program a corresponding multicast forwarding entry in its forwarding hardware. The entry can be in the multicast forwarding data structure in the TCAM of the forwarding hardware. In this way, in the event of a failover, the operational network device can readily start forwarding traffic based on the forwarding entry.

However, if the source network device is reachable from the device pair via an MC-LAG, the multicast traffic can be forwarded to both network devices of the device pair in accordance with standard MC-LAG forwarding rules. Moreover, if the requesting network device is coupled to the device pair via individual links, each of the network devices can forward the multicast traffic to the requesting network device based on their respective forwarding entries. As a result, the requesting network device can receive duplicate traffic. Here, traffic duplication can occur if the source network device is reachable via the MC-LAG and the requesting network device is reachable via individual links. To avoid traffic duplication, the primary device of the MC-LAG can program the entry in the forwarding hardware. On the other hand, the secondary device of the MC-LAG can maintain the entry in the memory without programming it in the forwarding hardware.

The network devices associated with the MC-LAG may automatically select the primary device based on a selection policy. For example, the network devices can compare each other's network addresses (e.g., media access control (MAC) or IP addresses) and select the network device with the higher (or lower) network address value as the primary device. The primary device can then forward the multicast traffic based on the entry in the forwarding hardware, while the secondary device can drop the multicast traffic. As a result, the requesting network device can receive one copy of the multicast traffic and avoid duplication. If the primary device becomes unavailable, the multicast traffic can no longer be forwarded from the primary device. The secondary device can then obtain the entry from the memory and program the entry in its forwarding hardware. Consequently, the secondary device can start forwarding the multicast traffic received from its ingress port.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

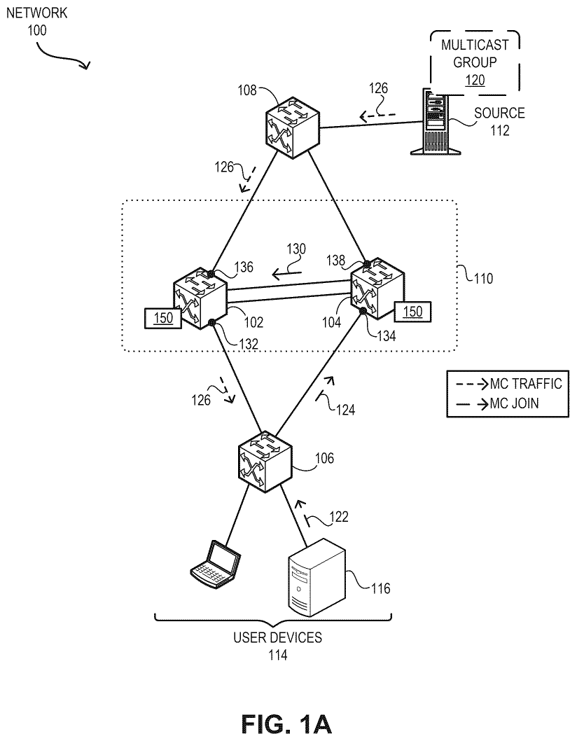

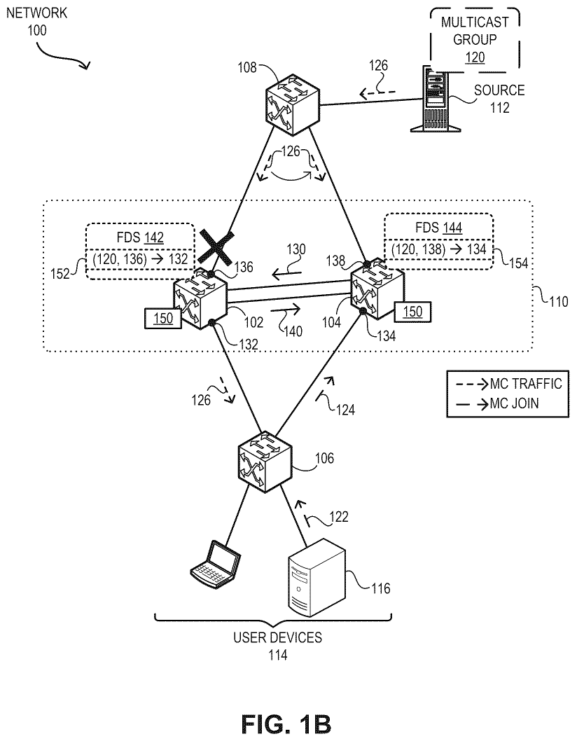

FIG. 1A illustrates an example of a network with a high-availability device pair operating as a PIM-BIDIR rendezvous point (RP), in accordance with an aspect of the present application. A network 100 can include a number of network devices (e.g., switches), and may include network devices, such as layer-2 and layer-3 hops, and tunnels. In some examples, network 100 can be an Ethernet network, InfiniBand network, or other network, and may use a corresponding communication protocol, such as IP, FibreChannel over Ethernet (FCoE), or other protocols. Network 100 can include network devices 102, 104, 106, and 108. These network devices can be individual physical network devices or networking units (e.g., switching units, such as switchblades) within a chassis. Network device 108 may be coupled to an external network (not shown in FIG. 1A) (e.g., a wide-area network (WAN), such as the Internet).

A respective network device in network 100 can be assigned a MAC address and an IP address and can include at least one processing resource. Examples of a processing resource can include, but are not limited to, a processor core, a graphics processing unit (GPU), and a tensor processing unit (TPU). The network device can also include at least one non-transitory computer-readable medium storing instructions that, when executed by the processing resource, causes the processing resource to perform one or more operations. The network device can further include forwarding hardware (e.g., the application-specific integrated circuit (ASIC) of the network device, which can at least incorporate a TCAM).

Network devices 102 and 104 can operate as a high-availability device pair 110, which can be associated with a distributed IP address 150. Hence, IP address 150 can be allocated to both network devices 102 and 104. Consequently, both network devices 102 and 104 can receive and forward packets based on IP address 150. Here, network devices in 102 and 104 can be peer network devices of each other in device pair 110. If network device 102 or 104 becomes unavailable, the other network device can facilitate failover and continue to forward traffic based on IP address 150. Typically, other devices, such as network devices 106 and 108, can be coupled to both network devices 102 and 104 either via an MC-LAG or individual links.

In the example in FIG. 1A, port 132 of network device 102 and port 134 of network device 104 can be coupled to network device 106 via corresponding individual links. Similarly, port 136 of network device 102 and port 138 of network device 104 can be coupled to network device 108 via corresponding individual links. In other words, network devices 106 and 108 can be coupled to both network devices 102 and 104 via individual links. Therefore, ports 132, 134, 136, and 138 can be configured as route-only ports that individually participate in the routing process (i.e., without being in a LAG). A user device 112, which can be the source of a multicast group 120, can be coupled to network device 108. Hence, network device 108 can be the source network device for multicast group 120. Multicast traffic 126 of multicast group 120 can be distributed in network 100 based on the PIM-BIDIR protocol. Multicast traffic 126 can include a flow of multicast data packets of multicast group 120, and hence, can also be referred to as multicast data flow 126 of multicast group 120.

Since network devices 102 and 104 are associated with IP address 150, network devices 106 and 108 can select one of network devices 102 and 104 for forwarding traffic. As a result, if a network device in device pair 110 becomes unavailable, the traffic can still be forwarded to the other network device in device pair 110 using IP address 150. Typically, device pair 110 can aggregate traffic from a plurality of user devices 114. As a result, device pair 110 can operate as the RP for distributing multicast traffic associated with the PIM-BIDIR protocol in network 100. Accordingly, multicast traffic 126 of multicast group 120 can be distributed via an RPMT in network 100.

Since device pair 110 can operate as the RP, the RPMT can be a source-independent multicast tree rooted at device pair 110. Hence, upon receiving multicast traffic 126 from source 112, network device 108 can forward multicast traffic 126 toward device pair 110. Network device 108 can have two paths to IP address 150. Network device 108 can select one of the paths (e.g., by applying a hash function to IP address 150) and forward multicast traffic 126 via the selected path. In this example, network device 108 can forward multicast traffic 126 to network device 102, which can receive multicast traffic 126 via port 136.

To receive multicast traffic 126, user device 116 can send a client join request 122 (e.g., an IGMP join) for multicast group 120. Therefore, user device 116 can also be referred to as host 116. Since network device 106 is coupled to host 116 that sends join request 122, network device 106 can be the requesting network device. Network device 106 can send a network join request 124 (e.g., a PIM-BIDIR join) to device pair 110 by sending it to IP address 150. Network device 106 can also have two paths to IP address 150. Network device 106 can select one of the paths and forward join request 124 via the selected path. In this example, network device 106 can forward join request 124 to network device 104, which can receive join request 124 via port 134. Accordingly, network device 104 can determine port 134 as an egress port for multicast group 120.

Because join request 124 is received by network device 104 and multicast traffic 126 is received by network device 102, network device 102 may not be aware of join request 124. As a result, network device 102 may not forward multicast traffic 126 to network device 106. Furthermore, if network device 102 becomes unavailable, network device 104 can start receiving multicast traffic 126 from source network device 108. However, when a multicast packet of multicast traffic 126 reaches network device 104, the forwarding hardware of network device 104 may not detect a matching forwarding entry. Network device 104 can then determine the corresponding route entry and program the entry in the forwarding hardware. This process can be inefficient and may cause traffic loss.

To address this issue, network devices 102 and 104 can exchange information associated with join request 124 and multicast traffic 126. When network device 104 receives join request 124 based on IP address 150 via port 134, network device 104 can determine port 134 as the egress port for multicast traffic 126. Network device 104 can then provide information 130 associated with join request 124 to network device 102. Information 130 can indicate multicast group 120 (e.g., the multicast IP address of multicast group 120) and the identifier of port 134. In some examples, network device 104 can send a notification message comprising information 130 (e.g., encoded in a type-length-value (TLV) format) to network device 102. If network devices 102 and 104 are on a shared chassis (e.g., switchblades in a chassis), information 130 can also be shared via a shared memory location of the chassis.

Network device 102 can then determine a corresponding port 132 of network device 102 by applying a matching policy on the port indicated in information 130. The matching policy can include a symmetric matching or a port mapping. For the symmetric matching, ports 132 and 134 can have the same port identifier. If the port identifier of port 134 is X (e.g., 1/1/1), the port identifier of port 132 can also be X. For example, if the port identifier of port 134 is 1/1/1, the port identifier of port 132 can also be 1/1/1. On the other hand, for the port mapping, network devices 102 and 104 can maintain a mapping between the respective port identifiers of ports 132 and 134 since they are coupled to the same network device 106. Network device 102 can then determine port 132 by looking up the identifier of port 134 in the mapping. The mapping can be provided by an administrator of network 100.

In this way, network device 102 can identify port 132 coupled to requesting network device 106. Subsequently, network device 102 can emulate the receiving of join request 124 for multicast group 120 via port 132. As a result, network device 102 can determine that multicast traffic 126 is requested from port 132. Accordingly, network device 102 can add port 132 as an egress port for multicast group 120. Upon receiving multicast traffic 126 via port 136, network device 102 can then forward multicast traffic 126 via port 132, which can include forwarding a respective packet of multicast traffic 126 via port 132. In this way, both network devices 102 and 104 can have egress ports 132 and 134, respectively, via which multicast traffic 126 can be forwarded. Hence, if any network device in device pair 110 receives multicast traffic 126, it can forward multicast traffic 126 to network device 106 via the local egress port associated with multicast group 120.

FIG. 1B illustrates an example of a high-availability device pair facilitating failover while operating as a PIM-BIDIR RP, in accordance with an aspect of the present application. Because device pair 110 can operate as the RP for multicast group 120, network device 108 can send multicast traffic 126 to IP address 150. When network device 102 receives the first packet of multicast traffic 126, network device 102 can program its forwarding hardware with a corresponding multicast forwarding entry 152. Entry 152 can be in multicast forwarding data structure 142 in the TCAM of the forwarding hardware. Entry 152 can indicate a multicast route associated with multicast group 120. Entry 152 can indicate port 136, which receives multicast traffic 126, as the ingress port for multicast group 120, and port 132, which has emulated to receive join request 124, as the egress port. Therefore, entry 152 can then indicate that the traffic belonging to multicast group 120 received from port 136 can be forwarded to port 132. It should be noted that entry 152 may indicate a plurality of egress ports (not shown in FIG. 1B) since network device 102 may receive (or emulate to receive) join requests from multiple downstream devices.

When network device 102 programs entry 152 in its forwarding hardware, network device 120 can synchronize information 140 indicated by the multicast route of entry 152 with network device 104. Information 140 can indicate multicast group 120 and respective identifiers of ingress port 136 and egress port 132 associated with multicast group 120. Based on the synchronization of information 130, both network devices 102 and 104 have already determined egress ports 132 and 134, respectively, of multicast traffic 126. Network device 102 can synchronize information 140 based on a notification message or via a shared memory. Based on the synchronization of information 140, network device 104 can determine port 138 as the ingress port for multicast traffic 126. Network device 104 can use the matching policy (e.g., the symmetric matching or port mapping) to determine port 138 based on the identifier of port 136.

Subsequently, network device 104 can program multicast forwarding entry 154 in its forwarding hardware. Entry 154 can be in forwarding data structure 144 in the TCAM of the forwarding hardware. Entry 154 can include a multicast route associated with multicast group 120, which can indicate that the traffic belonging to multicast group 120 received from port 138 can be forwarded to port 134. Suppose that network device 102 becomes unavailable due to a link or node failure (denoted with a cross). Hence, the path from network device 108 to device pair 110 (i.e., to IP address 150) via network device 102 can also become unavailable. Therefore, network device 108 can start forwarding multicast traffic 126 to network device 104. Since entry 154 can already be programmed in its forwarding hardware, network device 104 can readily start forwarding multicast traffic 126 based on entry 154. In this way, device pair 110 can mitigate traffic loss due to failover by preprogramming entry 154 in the forwarding hardware of network device 104.

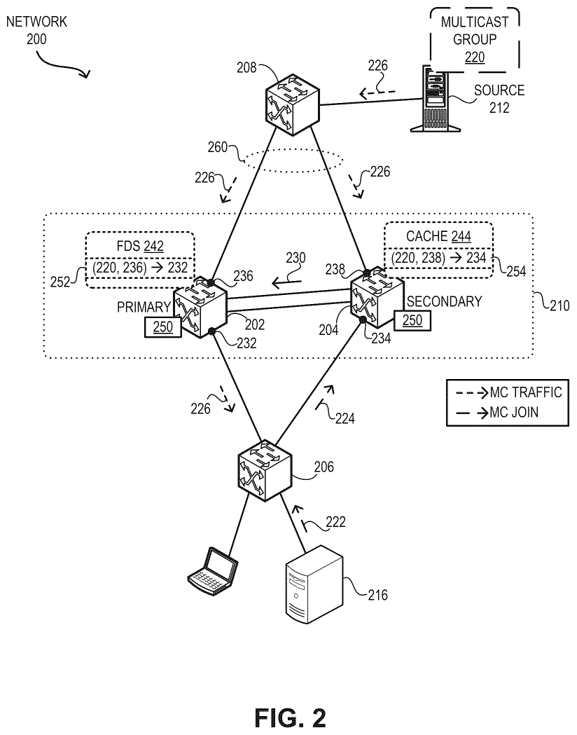

FIG. 2 illustrates an example of a network with an MC-LAG coupled to a high-availability device pair operating as a PIM-BIDIR RP, in accordance with an aspect of the present application. A network 200 can include a number of network devices (e.g., switches), and may include network devices, such as layer-2 and layer-3 hops, and tunnels. In some examples, network 200 can be an Ethernet network, InfiniBand network, or other network, and may use a corresponding communication protocol, such as IP, FCoE, or other protocols. Network 200 can include network devices 202, 204, 206, and 208. These network devices can be individual physical network devices or networking units (e.g., switching units, such as switchblades) within a chassis. Network device 208 may be coupled to an external network (not shown in FIG. 2) (e.g., a WAN, such as the Internet).

A respective network device in network 200 can be assigned a MAC address and an IP address and can include at least one processing resource. Examples of a processing resource can include, but are not limited to, a processor core, a GPU, and a TPU. The network device can also include at least one non-transitory computer-readable medium storing instructions that, when executed by the processing resource, causes the processing resource to perform one or more operations. The network device can further include forwarding hardware (e.g., the ASIC of the network device, which can at least incorporate a TCAM).

Network devices 202 and 204 can operate as a high-availability device pair 210, which can be associated with a distributed IP address 250. Hence, IP address 250 can be allocated to both network devices 202 and 204. Consequently, both network devices 202 and 204 can receive and forward packets based on IP address 250. Here, network devices in 202 and 204 can be peer network devices of each other in device pair 210. If network device 202 or 204 becomes unavailable, the other network device can facilitate failover and continue to forward traffic based on IP address 250. In the example in FIG. 2, port 232 of network device 202 and port 234 of network device 204 can be coupled to network device 206 via corresponding individual links. Therefore, ports 232 and 234 can be configured as route-only ports that individually participate in the routing process (i.e., without being in a LAG).

On the other hand, port 236 of network device 202 and port 238 of network device 204 can be coupled to network device 208 via an MC-LAG 260. Here, ports 236 and 238 can be MC-LAG ports. Network devices 202 and 204 may automatically select the primary device based on a selection policy. For example, network devices 202 and 204 can compare each other's network addresses (e.g., MAC or IP addresses) and select the network device with the higher (or lower) network address value as the primary device. In this example, network device 202 can be selected as the primary device for MC-LAG 260 based on the network addresses of network devices 202 and 204. Accordingly, network devices 202 and 204 can be the primary and secondary devices of MC-LAG 260, respectively.

A user device 212, which can be the source of a multicast group 220, can be coupled to network device 208. Hence, network device 208 can be the source network device for multicast group 220. Multicast traffic 226 of multicast group 220 can be distributed in network 200 based on the PIM-BIDIR protocol. Multicast traffic 226 can include a flow of multicast data packets of multicast group 220, and hence, can also be referred to as multicast data flow 226 of multicast group 220. Device pair 210 can operate as the RP for distributing multicast traffic associated with the PIM-BIDIR protocol in network 200. Accordingly, multicast traffic 226 of multicast group 220 can be distributed via an RPMT in network 200. Since device pair 210 can operate as the RP, the RPMT can be a source-independent multicast tree rooted at device pair 210. To receive multicast traffic 226, user device 216 can send a client join request 222 (e.g., an IGMP join) for multicast group 220. Therefore, user device 216 can also be referred to as host 216.

Since network device 206 is coupled to host 216 that sends join request 222, network device 206 can be the requesting network device. Network device 206 can send a network join request 224 (e.g., a PIM-BIDIR join) to device pair 210 by sending it to IP address 250. Network device 206 can have two paths to IP address 250. Network device 206 can select one of the paths and forward join request 224 via the selected path. In this example, network device 206 can forward join request 224 to network device 204, which can receive join request 224 via port 234. Accordingly, network device 204 can determine port 234 as an egress port for multicast group 220.

Network device 204 can then provide information 230 associated with join request 224 to network device 202. Information 230 can indicate multicast group 220 (e.g., the multicast IP address of multicast group 220) and the identifier of port 234. Network device 202 can then determine a corresponding port 232 of network device 202 by applying a matching policy on the port indicated in information 230. The matching policy can include a symmetric matching or a port mapping. In this way, network device 202 can identify port 232 coupled to requesting network device 206. Subsequently, network device 202 can emulate the receiving of join request 224 for multicast group 220 via port 232. As a result, network device 202 can add port 232 as an egress port for multicast group 220.

Since network device 208 is reachable from device pair 210 via MC-LAG 260, multicast traffic 226 can be forwarded to both network devices 202 and 204 in accordance with standard MC-LAG forwarding rules. When network devices 202 and 204 receive the first packet of multicast traffic 226, network devices 202 and 204 can program their forwarding hardware with corresponding multicast forwarding entries. For example, network device 202 can generate an entry 252 in multicast forwarding data structure 242 stored in the TCAM of the forwarding hardware. Entry 252 can include a multicast route indicating that the traffic belonging to multicast group 220 received from port 236 can be forwarded to port 232. Network device 204 may also generate a similar entry indicating that the traffic belonging to multicast group 220 received from port 238 can be forwarded to port 234.

However, since network device 208 is coupled to device pair 210 via individual links, both network devices 202 and 204 can forward multicast traffic 226 to network device 208. As a result, network device 208 can receive duplicate traffic. Here, traffic duplication occurs because source network device 208 is reachable via MC-LAG 260, and requesting network device 206 is reachable via individual links from device pair 210. To avoid traffic duplication, network device 202, which is the primary device of MC-LAG 260, can program entry 252 in its forwarding hardware. On the other hand, network device 204, which is the secondary device of MC-LAG 260, can generate entry 254 upon receiving the first packet of multicast traffic 226. Entry 254 can include a multicast route indicating that traffic belonging to multicast group 220 received from port 238 can be forwarded to port 234. Instead of programming entry 254 in the forwarding hardware, network device 204 can store entry 254 in a cache 244 (e.g., a temporary storage) in the memory of network device 204.

Network device 202 can then forward multicast traffic 226 based on entry 252 in the forwarding hardware. Because the forwarding hardware of network device 204 does not include a forwarding entry for multicast group 220, network device 204 can drop multicast traffic 226. As a result, network device 206 can receive one copy of multicast traffic 226 and avoid duplication. If network device 202 becomes unavailable, multicast traffic 226 can no longer be forwarded from network device 202. Network device 204 can then obtain entry 254 from cache 244 and program entry 254 in its forwarding hardware. Since entry 254 indicates that traffic received from port 238 can be forwarded to port 234, network device 204 can start forwarding multicast traffic 226 received from MC-LAG 260 (i.e., received from port 238) to network device 206 via port 234.

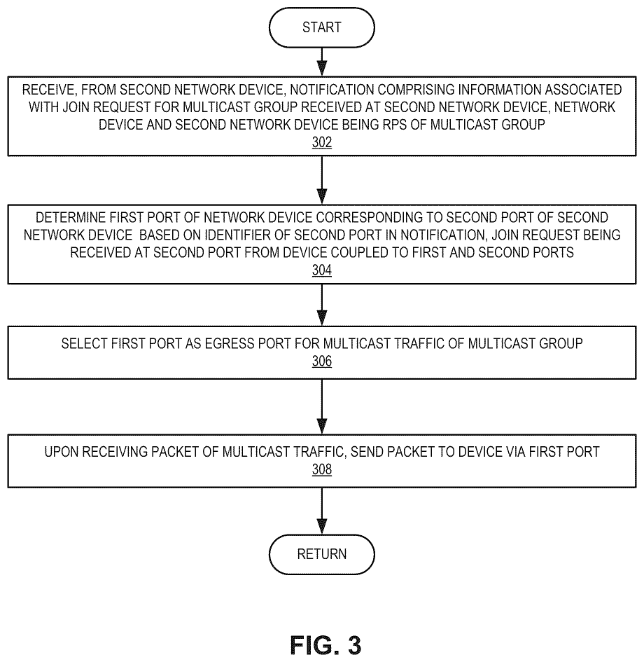

FIG. 3 presents a flowchart illustrating an example of a process of a network device in a high-availability device pair processing multicast traffic while operating as a PIM-BIDIR RP, in accordance with an aspect of the present application. During operation, the network device can receive, from a second network device, a notification comprising information associated with a join request for a multicast group received at the second network device (operation 302). Here, the network device and the second network device can be the RPs of the multicast group. The notification can indicate the multicast group (e.g., the multicast IP address associated with the multicast group) and the identifier of the port that has received the join request. In the example in FIG. 1A, network device 102 can receive a notification comprising information 130 from network device 104. Information 130 can indicate the multicast IP address associated with multicast group 120 and an identifier of port 134, which has received a join request for multicast group 120.

The network device can then determine a first port of the network device corresponding to a second port of the second network device based on an identifier of the second port in the notification (operation 304). Here, the join request can be received at the second port from a device coupled to the first and second ports. Therefore, the device is coupled to both the network device and the second network device via the first and second ports, respectively. Since the second network device has received the join request from the device via the second port, the network device can determine the first port coupled to the device based on the port identifier of the second port. For example, the first and second ports may have the same identifier. In the example in FIG. 1A, network device 102 can determine port 132 based on the identifier of port 134, which has received join request 124 from network device 106. Here, network device 106 can be coupled to both ports 132 and 134. If the port identifier of port 134 is X, the corresponding port identifier of port 132 can also be X.

The network device can select the first port as an egress port for the multicast traffic of the multicast group (operation 306). Upon determining the first port, the network device can emulate the receiving of the join request for the multicast group via the first port. As a result, the network device can determine that the multicast traffic of the multicast group is requested from the first port. Accordingly, the network device can select the first port as the egress port for the multicast traffic of the multicast group. In the example in FIG. 1A, network device 102 can determine port 132 and emulate receiving a join request via port 132. Accordingly, the network device can select port 132 as the egress port for multicast traffic 126 of multicast group 120.

Subsequently, upon receiving a packet of the multicast traffic, the network device can send the packet to the device via the first port (operation 308). Since the network device has determined the first port as the egress port for the multicast traffic of the multicast group based on the received information, the network device can forward packets of the multicast traffic via the first port. In the example in FIG. 1A, when network device 102 receives multicast traffic 126, network device 102 can send multicast traffic 126 to network device 106 via port 132.

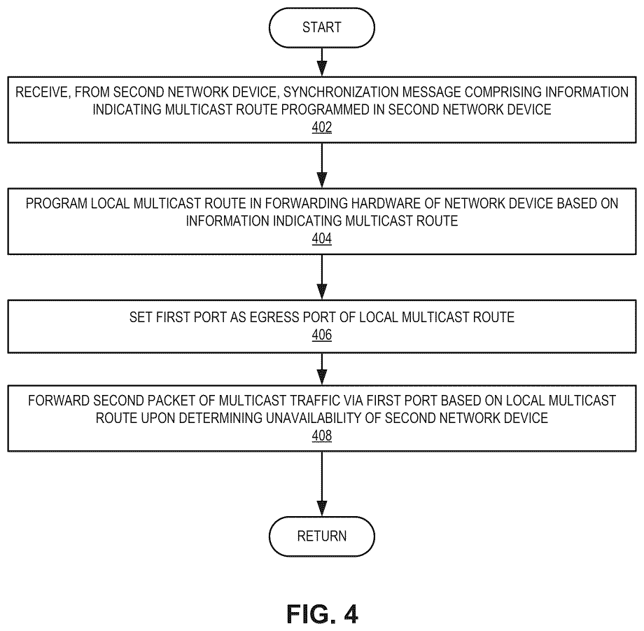

FIG. 4 presents a flowchart illustrating an example of a process of a network device in a high-availability device pair facilitating efficient failover, in accordance with an aspect of the present application. During operation, the network device can receive, from the second network device, a synchronization message comprising information indicating a multicast route programmed in the second network device (operation 402). Here, the network device and the second network device can correspond to the network device and the second network device of FIG. 3, respectively. The second network device can receive the multicast traffic from a source network device and program the multicast route in its forwarding hardware. The second network device can then synchronize the multicast route with the network device by sending the synchronization message. In the example in FIG. 1B, network device 104 can receive information 140 indicating the multicast route of entry 152 programmed in the forwarding hardware of network device 102.

The network device can then program the multicast route in the forwarding hardware of the network device based on the information indicating the multicast route (operation 404). Based on the synchronization of the multicast route, the network device can determine the local ingress port of the multicast traffic using the matching policy (e.g., symmetric matching or port mapping). Accordingly, the network device can also program a corresponding multicast forwarding entry in its forwarding hardware. The entry can be in the multicast forwarding data structure in the TCAM of the forwarding hardware. In the example in FIG. 1B, network device 104 program entry 154 in the forwarding hardware of network device 104 based on information 140 received from network device 102.

The network device can set the first port as the egress port of the local multicast route (operation 406). Based on the synchronization of the join request, as described in conjunction with FIG. 3, the network device has already determined the first port as the egress port for the multicast traffic of the multicast group. Accordingly, the network device can set the first port as the egress port in the multicast route programmed in the forwarding hardware of the network device. In the example in FIG. 1B, network device 104 has determined port 134 as the egress port for the multicast traffic associated with multicast group 120. Hence, network device 104 can set port 134 as the egress port in entry 154 in the forwarding hardware.

The network device can then forward a second packet of the multicast traffic via the first port based on the local multicast route upon determining the unavailability of the second network device (operation 408). If the second network device becomes unavailable, the multicast traffic can be forwarded to the network device. Since the multicast route can already be programmed in its forwarding hardware, the network device can readily start forwarding the multicast traffic based on the multicast route. In the example in FIG. 1B, if network device 102 becomes unavailable, network device 104 can receive multicast traffic 126 via port 138. Network device 104 can then start forwarding multicast traffic 126 based on entry 154.

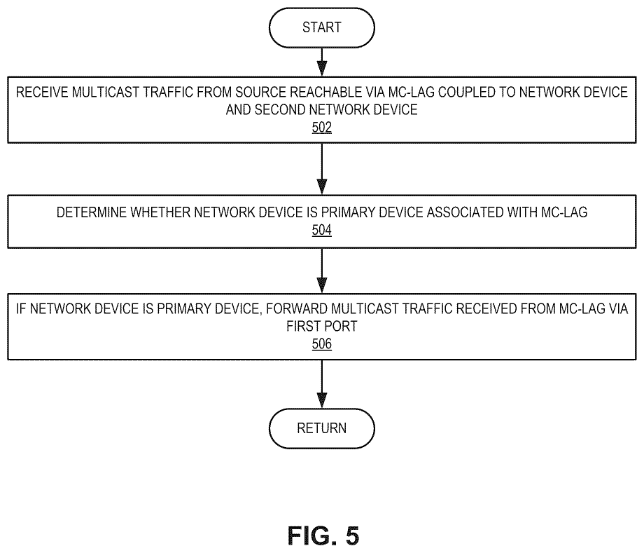

FIG. 5 presents a flowchart illustrating an example of a process of a network device in a high-availability device pair processing multicast traffic received from an MC-LAG while operating as a PIM-BIDIR RP, in accordance with an aspect of the present application. During operation, the network device can receive multicast traffic from a source reachable via an MC-LAG coupled to the network device and the second network device (operation 502). Here, the network device and the second network device can correspond to the network device and the second network device of FIG. 3, respectively. Based on the standard forwarding rule associated with the MC-LAG, multicast traffic can be forwarded to both the network device and the second network device. Therefore, the network device, along with the second network device, can receive the multicast traffic. In the example in FIG. 2, network devices 202 and 204 can receive multicast traffic 226 via MC-LAG 260.

The network device can then determine whether the network device is the primary device associated with the MC-LAG (operation 504). Since both network devices can receive the multicast traffic, they may both forward the multicast traffic to a downstream device, thereby causing traffic duplication. To avoid traffic duplication, only the primary device of the MC-LAG may forward the multicast traffic received from an MC-LAG. Typically, a respective network device associated with the MC-LAG may automatically determine the primary device based on a selection policy. Accordingly, the network device can determine whether it has been selected as the primary device. If the network device is the primary device, the network device can forward the multicast traffic received from the MC-LAG via the first port (operation 506). In the example in FIG. 2, network device 202 can determine itself as the primary device associated with MC-LAG 260. Hence, network device 202 can forward multicast traffic 226 received from MC-LAG 260 via port 232 to network device 206.

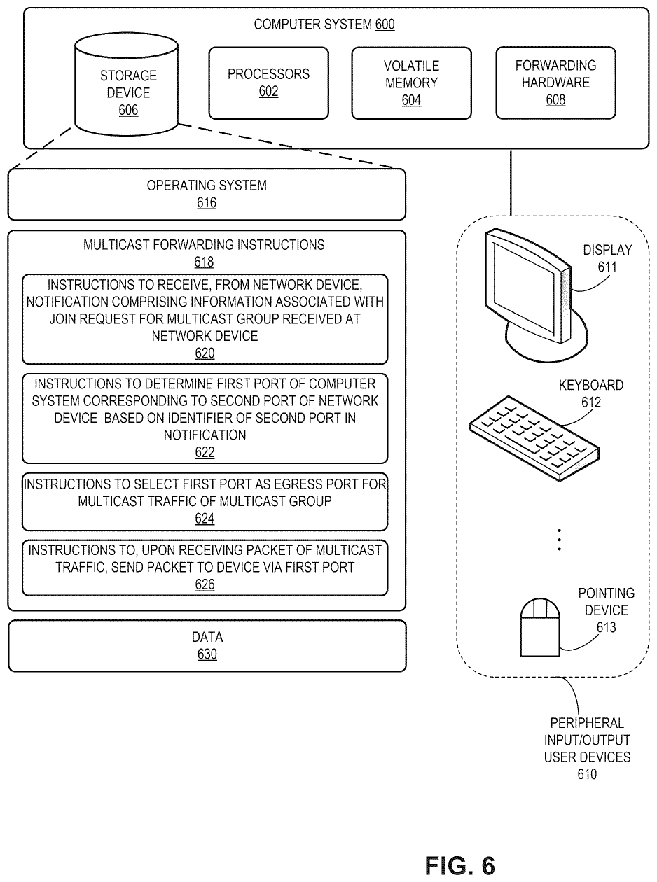

FIG. 6 illustrates an example of a computing system facilitating a PIM-BIDIR RP on a high-availability device pair, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a TCAM. Storage device 606 includes a non-transitory computer-readable storage medium and stores an operating system 616, multicast forwarding instructions 618, and data 630. Computer system 600 may include fewer or more entities or instructions than those shown in FIG. 6.

Multicast forwarding instructions 618 can include instructions, which when executed by computer system 600, can cause computer system 600 to perform methods and/or processes described in this disclosure. Multicast forwarding instructions 618 can be executed on at least one of processors 602, forwarding hardware 608, or a combination thereof. Computer system 600 can be a network device, such as network devices 102 and 104 in FIGS. 1A and 1B and network devices 202 and 204 in FIG. 2. Specifically, multicast forwarding instructions 618 may include instructions 620 to receive, from a network device, a notification comprising information associated with a join request for a multicast group received at the network device. The notification can indicate the multicast group (e.g., the multicast IP address associated with the multicast group) and the identifier of the port that has received the join request. In the example in FIG. 1A, network device 102 can receive information 130 indicating the multicast IP address associated with multicast group 120 and an identifier of port 134, which has received a join request for multicast group 120.

Multicast forwarding instructions 618 may also include instructions 622 to determine a first port of computer system 600 corresponding to a second port of the network device based on an identifier of the second port in the notification. Since the network device has received the join request via the second port, computer system 600 can determine the first port based on the port identifier of the second port. In the example in FIG. 1A, network device 102 can determine port 132 based on the identifier of port 134, which has received join request 124 from network device 106. Furthermore, multicast forwarding instructions 618 may also include instructions 624 to select the first port as an egress port for the multicast traffic of the multicast group. Upon determining the first port, computer system 600 can emulate the receiving of the join request for the multicast group via the first port and determine the first port as the egress port. In the example in FIG. 1A, network device 102 can emulate receiving a join request via port 132 and select port 132 as an egress port for multicast traffic 126 of multicast group 120.

Multicast forwarding instructions 618 may include instructions 626 to, upon receiving a packet of the multicast traffic, send the packet to the device via the first port. Since the first port can be coupled to the device and is selected as the egress port for the multicast traffic of the multicast group, computer system 600 can forward packets of the multicast traffic via the first port even without receiving a corresponding join request via the first port. In the example in FIG. 1A, when network device 102 receives multicast traffic 126, network device 102 can send multicast traffic 126 to network device 106 via port 132. Data 630 can include any data that is required as input, or that is generated as output by the methods, operations, communications, and/or processes described in this disclosure. Specifically, data 630 can include information indicating a matching policy and forwarding information associated with a distributed IP address. Data 630 can also include forwarding entries in a forwarding data structure in forwarding hardware 608 (e.g., entries 152 and 154 in forwarding data structures 142 and 144, respectively, of FIG. 1B).

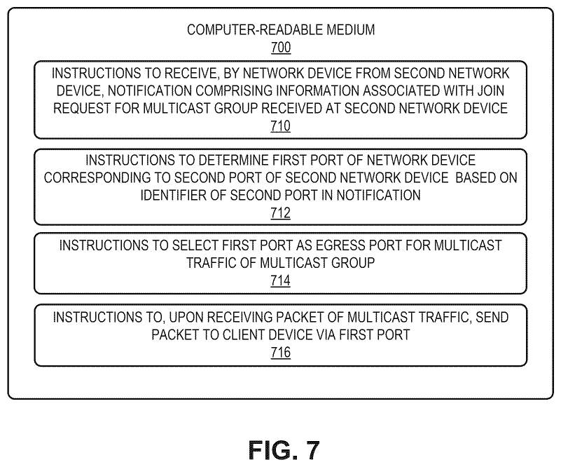

Computer system 600 and multicast forwarding instructions 618 may include more instructions than those shown in FIG. 6. For example, multicast forwarding instructions 618 can also store instructions for receiving multicast traffic from network device 108 of FIG. 1A; synchronizing forwarding information 140 of FIG. 1B; programming a forwarding entry in the forwarding hardware based on forwarding information 140 of FIG. 1B; storing forwarding entry 254 in cache 244 in response to network device 204 being a secondary device of MC-LAG 260 of FIG. 2; upon detecting a failure of network device 202, network device 204 programming its forwarding hardware with entry 254 of cache 244 in FIG. 2; the operations depicted in the flowcharts of FIGS. 3, 4, and 5; and the instructions of non-transitory CRM 700 in FIG. 7.

FIG. 7 illustrates an example of a CRM facilitating a PIM-BIDIR RP on a high-availability device pair, in accordance with an aspect of the present application. CRM 700 can include one or more non-transitory computer-readable mediums or devices storing instructions that when executed by a computer or processor cause the computer or processor to perform a method. Therefore, the instructions in CRM 700 can be stored in one or more non-transitory computer-readable mediums or devices. CRM 700 can store instructions 710 to receive, by a network device from a second network device, a notification comprising information associated with a join request for a multicast group received at the second network device. In the example in FIG. 1A, network device 102 can receive information 130 indicating the multicast IP address associated with multicast group 120 and an identifier of port 134, which has received a join request for multicast group 120. CRM 700 can also include instructions 712 to determine a first port of the network device corresponding to a second port of the second network device based on an identifier of the second port in the notification. In the example in FIG. 1A, network device 102 can determine port 132 based on the identifier of port 134, which has received join request 124 from network device 106.

CRM 700 can include instructions 714 to select the first port as an egress port for the multicast traffic of the multicast group. In the example in FIG. 1A, network device 102 can emulate receiving a join request via port 132 and select port 132 as an egress port for multicast traffic 126 of multicast group 120. CRM 700 can also include instructions 716 to, upon receiving a packet of the multicast traffic, send the packet to the device via the first port. In the example in FIG. 1A, when network device 102 receives multicast traffic 126, network device 102 can send multicast traffic 126 to network device 106 via port 132.

CRM 700 may include more instructions than those shown in FIG. 7. For example, CRM 700 can also store instructions for receiving multicast traffic from network device 108 of FIG. 1A; synchronizing forwarding information 140 of FIG. 1B; programming a forwarding entry in the forwarding hardware based on forwarding information 140 of FIG. 1B; storing forwarding entry 254 in cache 244 in response to network device 204 being a secondary device of MC-LAG 260 of FIG. 2; upon detecting a failure of network device 202, network device 204 programming its forwarding hardware with entry 254 of cache 244 in FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in a network. During operation, the network device can receive, from a second network device, a notification comprising information associated with a join request for a multicast group received at the second network device. Here, the network device and the second network device can be RPs for the multicast group. The network device can determine, based on the notification, a first port of the network device corresponding to a second port of the second network device. The join request can be received at the second port from a device coupled to the first and second ports. The network device can then select the first port as an egress port for multicast traffic of the multicast group and, upon receiving a packet of the multicast traffic, send the packet to the device via the first port.

In a variation on this aspect, the network device can determine the first port by identifying the first port based on a port identifier of the second port in the second network device. Here, the notification can include the port identifier of the second port.

In a variation on this aspect, the network device can receive a synchronization message from the second network device. The synchronization message can include information indicating a multicast route programmed in the second network device.

In a further variation, the network device can program a local multicast route in forwarding hardware of the first network device based on the information indicating the multicast route. The network device can then set the first port as an egress port of the local multicast route.

In a further variation, the network device can determine the unavailability of the second network device. The network device can then forward a second packet of the multicast traffic via the first port based on the local multicast route.

In a variation on this aspect, a source of the multicast group can be reachable via an MC-LAG coupled to the first and second network devices.

In a further variation, the network device can determine whether the first network device is a primary device associated with the MC-LAG. If the first network device is the primary device, the network device can forward the multicast traffic received from the MC-LAG via the first port.

In a variation on this aspect, the first and second network devices are RPs associated with a PIM-BIDIR protocol.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
receiving, by a first network device from a second network device, a notification comprising information associated with a join request for a multicast group received at the second network device, wherein the first and second network devices are rendezvous points (RPs) for the multicast group;
determining, based on the notification, a first port of the first network device corresponding to a second port of the second network device, wherein the join request is received at the second port from a device coupled to the first and second ports;
selecting the first port as an egress port for multicast traffic of the multicast group; and
in response to receiving a packet of the multicast traffic, sending the packet to the device via the first port.

2. The method of claim 1, wherein determining the first port further comprises identifying the first port based on a port identifier of the second port in the second network device, and wherein the notification comprises the port identifier of the second port.

3. The method of claim 1, further comprising receiving, by the first network device, a synchronization message from the second network device, wherein the synchronization message comprises information indicating a multicast route programmed in the second network device.

4. The method of claim 3, further comprising:
programming a local multicast route in forwarding hardware of the first network device based on the information indicating the multicast route; and
setting the first port as an egress port of the local multicast route.

5. The method of claim 4, further comprising:
determining an unavailability of the second network device; and
forwarding a second packet of the multicast traffic via the first port based on the local multicast route.

6. The method of claim 1, wherein a source of the multicast group is reachable via a multi-chassis link aggregation group (MC-LAG) coupled to the first and second network devices.

7. The method of claim 6, further comprising:
determining whether the first network device is a primary device associated with the MC-LAG; and
in response to the first network device being the primary device, forwarding the multicast traffic received from the MC-LAG via the first port.

8. The method of claim 1, wherein the first and second network devices are RPs associated with a bidirectional Protocol Independent Multicast (PIM-BIDIR) protocol.

9. A non-transitory computer-readable storage medium storing instructions to:
receive, by a first network device from a second network device, a notification comprising information associated with a join request for a multicast group received at the second network device, wherein the first and second network devices are rendezvous points (RPs) for the multicast group;
determine, based on the notification, a first port of the first network device corresponding to a second port of the second network device, wherein the join request is received at the second port from a device coupled to the first and second ports;
select the first port as an egress port for multicast traffic of the multicast group; and
in response to receiving a packet of the multicast traffic, send the packet to the device via the first port.

10. The non-transitory computer-readable storage medium of claim 9, wherein, to determine the first port, the instructions are further to identify the first port based on a port identifier of the second port in the second network device, and wherein the notification comprises the port identifier of the second port.

11. The non-transitory computer-readable storage medium of claim 9, wherein the instructions are further to receive, by the first network device, a synchronization message from the second network device, wherein the synchronization message comprises information indicating a multicast route programmed in the second network device.

12. The non-transitory computer-readable storage medium of claim 11, wherein the instructions are further to:
program a local multicast route in forwarding hardware of the first network device based on the information indicating the multicast route; and
set the first port as an egress port of the local multicast route.

13. The non-transitory computer-readable storage medium of claim 12, wherein the instructions are further to:
determine an unavailability of the second network device; and
forward a second packet of the multicast traffic via the first port based on the local multicast route.

14. The non-transitory computer-readable storage medium of claim 9, wherein a source of the multicast group is reachable via a multi-chassis link aggregation group (MC-LAG) coupled to the first and second network devices.

15. The non-transitory computer-readable storage medium of claim 14, wherein the instructions are further to:
determine whether the first network device is a primary device associated with the MC-LAG; and
in response to the first network device being the primary device, forward the multicast traffic received from the MC-LAG via the first port.

16. The non-transitory computer-readable storage medium of claim 9, wherein the first and second network devices are RPs associated with a bidirectional Protocol Independent Multicast (PIM-BIDIR) protocol.

17. A computer system, comprising:
at least one processing resource; and
a non-transitory computer-readable storage medium storing instructions that when executed by the at least one processing resource cause the computer system to:
receive, from a second computer system, a notification comprising information associated with a join request for a multicast group received at the second computer system, wherein the computer system and the second computer system are rendezvous points (RPs) for the multicast group;
determine, based on the notification, a first port of the computer system corresponding to a second port of the second computer system, wherein the join request is received at the second port from a device coupled to the first and second ports;
select the first port as an egress port for multicast traffic of the multicast group; and
in response to receiving a packet of the multicast traffic, send the packet to the device via the first port.

18. The computer system of claim 17, wherein the instructions that when executed by the at least one processing resource cause the computer system to receive a synchronization message from the second computer system, wherein the synchronization message comprises information indicating a multicast route programmed in the second computer system.

19. The computer system of claim 18, wherein the instructions that when executed by the at least one processing resource cause the computer system to:
program a local multicast route in forwarding hardware of the computer system based on the information indicating the multicast route; and
set the first port as an egress port of the local multicast route.

20. The computer system of claim 18, wherein a source of the multicast group is reachable via a multi-chassis link aggregation group (MC-LAG) coupled to the computer system and the second computer system; and
wherein the instructions that when executed by the at least one processing resource cause the computer system to:
determine whether the computer system is a primary device associated with the MC-LAG; and
in response to the computer system device being the primary device, forward the multicast traffic received from the MC-LAG via the first port.
